(19) United States
(12) Patent Application Publication
(10) Pub. No.: US 2013/0296458 A1
(43) Pub. Date: Nov. 7, 2013

(54) Continuous Method For Reacting Polymers Carrying Acid Groups, With Amines

(71) Applicants: Matthias Krull, Harxheim (DE); Roman Morschhaeuser, Mainz (DE)

(72) Inventors: Matthias Krull, Harxheim (DE); Roman Morschhaeuser, Mainz (DE)

(73) Assignee: CLARIANT FINANCE (BVI) LIMITED, Tortola (VG)

(21) Appl. No.: 13/976,709

(22) PCT Filed: Dec. 8, 2011
(86) PCT No.: PCT/EP2011/006173

§ 371 Date: Jun. 27, 2013

(30) Foreign Application Priority Data
Dec. 30, 2010 (DE) 10 2010 056 579.2

(51) Int. Cl. C08J 3/28

(52) U.S. Cl. CPC C08J 3/28
USPC 522/176

(57) ABSTRACT

The invention relates to a method for reacting synthetic poly(carboxylic acids) (A), containing at least 10 repetitive structural units of formula (I), wherein R⁹ represents hydrogen, a C₁ to C₄-alkyl group or a group of formula —CH₂—COOH, R¹⁹ represents hydrogen or a C₁ to C₄-alkyl group, R¹¹ represents hydrogen, a C₁ to C₄ alkyl group or —COOH or with amines (B) of general formula (II) HNR¹R² (II), wherein R¹represents a hydrocarbon group having 3 to 50 C atoms, which can be substituted or can contain heteroatoms, and R² represents hydrogen or a hydrocarbon group having 1 to 50 C atoms, which can be substituted or can contain heteroatoms, or R¹ and R² together form a ring with the nitrogen atom to which they are bound. According to the invention, a reaction mixture containing at least one synthetic poly(carboxylic acid) (A) and at least one amine of formula (II) in a solvent mixture which contains water, and with respect to the weight of the solvent mixture, 0.1-75 wt.-% of at least one organic solvent which can be mixed with water, said organic solvent having a dielectric constant of at least 10 when measured at 25° C., is introduced into a reaction path and is exposed to microwave radiation when it flows through the reaction path. Said reaction mixture is heated to temperatures over 100° C. by the microwave radiation in the reaction path.

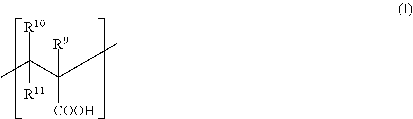

The present invention relates to a continuous process for reacting polymers bearing acid groups by polymer-analogous amidation of solutions of the polymers in a microwave field.

Hydrophobically modified water-soluble synthetic polymers have gained increasing industrial significance in the last few years. These are usually polymers formed mainly from monomers bearing hydrophilic groups and a smaller proportion of monomers bearing hydrophobic groups. These water-soluble polymers aggregate in aqueous solutions owing to intra- and/or intermolecular interactions of the hydrophobic groups with micelle-like structures. As a result, the hydrophobically modified polymers, compared to standard water-soluble polymers, cause an increase in viscosity through the formation of three-dimensional networks at low concentrations, without requiring extremely high molar masses. Such “associative thickeners” efficiently control the rheological properties of water-based liquids in many industrial applications or formulations, for example in paints and coatings, paper, drilling fluids and in oil production. In pharmaceutical and cosmetic applications too, these polymers find use, for example, as stabilizers of colloidal dispersions, of emulsions, liposomes or (nano)particles. In addition, they are used as dispersants for pigments and dyes, the modified polymer acting here as a dispersant for hydrophobic particles through anchoring of the hydrophobic polymer segments on the solid surface and through expansion of the charged hydrophilic groups into the volume phase.

A special case of the hydrophobically modified water-soluble polymers is that of what are called LCST (Lower Critical Solution Temperature) polymers, the side chains of which lose water solubility with rising temperature and thus lead to aggregation or precipitation of the polymer when the temperature increases. Such polymers are of great interest, for example, in mineral oil production as drilling mud additives.

The rheological properties of hydrophobically modified water-soluble synthetic polymers can be adjusted within wide limits, for example through selection of the hydrophobic group and/or the level of modification, and hence adapted to a wide variety of applications.

An important group of hydrophobically associating water-soluble macromolecules is that of hydrophobically modified synthetic poly(carboxylic acids) and poly(carboxamides). These can be prepared, for example, by copolymerization of ethylenically unsaturated carboxylic acids and/or carboxamides with appropriate monomers bearing hydrophobic groups. Hydrophobic comonomers have been found to be especially ethylenically unsaturated carboxamides which are substituted on the nitrogen, since they have copolymerization parameters comparable to the hydrophilic monomers but an increased hydrolysis stability compared to corresponding esters. However, the industrial availability thereof is limited, both in terms of the variation of the substituents and in terms of volume, and the synthesis thereof is complex and costly. It is typically effected via the reaction of reactive carboxylic acid derivatives, such as anhydrides or acid chlorides, with amines, forming equimolar amounts of by-products which have to be removed and disposed of. Furthermore, the preparation of random copolymers often presents difficulties owing to different solubilities of hydrophilic and hydrophobic monomers.

Alternatively, such polymers are also obtainable by polymer-analogous reactions on synthetic, higher molecular weight poly(carboxylic acids), which are available industrially in large volumes. According to the prior art, such polymer-analogous reactions between poly(carboxylic acids) and amines can be performed with coupling reagents, for example N,N′-dicyclohexylcarbodiimide (DCC). Problems which arise are again by-products which form as a result of the process and the different solubilities of the reactants, which often leads to inhomogeneous products. As long as the poly(carboxylic acids) are sufficiently oil-soluble, a condensation in organic solvents under azeotropic separation of the water of reaction is also possible.

A more recent approach to the synthesis of carboxamides is the microwave-promoted direct reaction of carboxylic acids and amines to give amides. In contrast to conventional processes, no activation of the carboxylic acid using, for example, acid chlorides, acid anhydrides, esters or coupling reagents is required, which means that these processes are of great economic and environmental interest.

Tetrahedron Letters 2005, 46, 3751-3754 discloses a multitude of amides which have been synthesized using microwave radiation.

Macromolecular Chemistry and Physics (2008), 209, 1942-1947 discloses the polymer-analogous amidation of a poly(ether sulfone) bearing acid groups with 4-aminobenzoic acid in apolar solvents under microwave irradiation.

J. Polym. Sci., Part A: Polym. Chem. (2007), 45, 3659-3667 discloses the polymer-analogous amidation of poly(ethylene-co-acrylic acid) with excess 2-(2-aminoethoxy)ethanol in toluene under microwave irradiation, giving amidated, hydroxy-functionalized polymers. After an irradiation time of 90 minutes at 240° C. a conversion of 87% of the acid groups is obtained.

WO 2009/121488 discloses the condensation of carboxylic acids with amines to amides in a microwave field in the presence of superheated water.

The teaching of WO 2009/121488, however, is confined to the reaction of monomeric carboxylic acids. This process cannot be transposed directly to synthetic poly(carboxylic acids) of higher molecular weight. More highly concentrated aqueous solutions of synthetic poly(carboxylic acids) of relatively high molecular weight, as required for reactions on the industrial scale, possess a very high viscosity, and this hinders not only the preparation of homogeneous reaction mixtures with amines but also their handling when stirring or pumping, for example. For partial amidation of the carboxyl groups, in particular, the preparation of aqueous solutions of ammonium salts with statistical distribution of the ammonium groups over the entire chain length of the polymer gives rise, typically, to considerable difficulties, owing to differences in viscosity and solubility between poly(carboxylic acid) and amine. For instance, when reacting synthetic poly(carboxylic acids) of relatively high molecular weight with hydrophobic amines of correspondingly low water-solubility, it is often impossible to achieve satisfactory results even with very vigorous and intense stirring and/or mixing with specific stirring and/or mixing assemblies. Furthermore, the viscosity of aqueous solutions of synthetic poly(carboxylic acids), which is not negligible even in the unreacted reaction mixture, and which rises sharply further as the formation of hydrophobically modified structural units sets in, necessitates specialty conveying assemblies in order to maintain a flow of the reaction mixture, necessary in continuous operations, through the irradiation zone. Often, even high-power pumps are inadequate for the conveying of concentrated solutions, and it is necessary to work with conveying units, for example spirals or archimedean screws. In the case of microwave-promoted reactions, as well as mechanical strength, specific demands are made on the material of such units, for example microwave transparency, and ensuring these entails a high level of cost and inconvenience. Moreover, such mechanical apparatuses limit the geometry of the irradiation zone.

The problem addressed was consequently that of providing a continuous process for polymer-analogous modification of synthetic poly(carboxylic acids), in which the properties of synthetic poly(carboxylic acids) can be modified in a simple and inexpensive manner in volumes of industrial interest. More particularly, there is to be no occurrence in the reaction mixture of high viscosities which entail the use of specific conveying units. It shall be possible to influence the solubility and aggregation characteristics of the polymers prepared within wide limits. To achieve constant product properties both within a reaction batch and between different reaction batches, the modification is to be very substantially homogeneous, meaning a random distribution over the entire polymer. Furthermore, no significant amounts of by-products of toxicological and/or environmental concern are to arise.

It has been found that, surprisingly, synthetic poly(carboxylic acids) can be amidated in solutions in water and particular water-miscible solvents with amines under the influence of microwaves at temperatures above 100° C. in a continuous process. In the course of the process, the viscosity rises only slightly, if at all. In this way, poly(carboxylic acids) can be modified, for example, to render them hydrophobic or thermally associative. The solubility of polymers modified in such a way gives no pointers to the presence of any large hydrophilic or hydrophobic polymer blocks. Since a multitude of different amines is available inexpensively and in industrial volumes, it is thus possible to modify the properties of synthetic poly(carboxylic acids) within wide limits. In these processes—aside from water of reaction—no by-products which have to be removed and disposed of are obtained.

The invention accordingly provides a continuous process for reacting synthetic poly(carboxylic acids) (A) containing at least 10 repeat structural units of the formula (I)

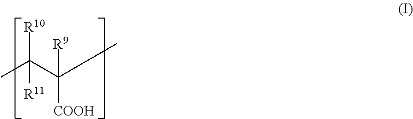

in which

R⁹ is hydrogen, a C₁- to C₄-alkyl group or a group of the formula —CH₂—COOH

R¹⁰ is hydrogen or a C₁ to C₄-alkyl group

R¹¹ is hydrogen, a C₁- to C₄-alkyl group or —COON,

with amines (B) of the formula (II)

HNR¹R² (II)

in which

R¹ is a hydrocaryl radical which has 3 to 50 carbon atoms and may be substituted or contain heteroatoms, and

R² is hydrogen or a hydrocarbyl radical which has 1 to 50 carbon atoms, which may be substituted or contain heteroatoms, or

R¹ and R² together with the nitrogen atom to which they are bonded form a ring in which a reaction mixture comprising at least one synthetic poly(carboxylic acid) (A) and at least one amine of the formula (II) in a solvent mixture comprising water and, based on the weight of the solvent mixture, 0.1-75% by weight of at least one water-miscible organic solvent, where the organic solvent has a dielectric constant measured at 25° C. of at least 10, is introduced into a reaction zone, and exposed to microwave radiation as it flows through the reaction zone, the reaction mixture in the reaction zone being heated to temperatures above 100° C. by the microwave irradiation.

The invention further provides polymer-analogously modified synthetic poly(carboxylic acids) prepared by the process according to the invention.

Preferably, R⁹ is hydrogen or a methyl group. Additionally preferably, R¹⁰ is hydrogen. Additionally preferably, R¹¹ is hydrogen or —COOH. In a specific embodiment, R⁹, R¹⁰ and R¹¹ are each hydrogen. In a further specific embodiment, R⁹ is a methyl group and R¹⁰ and R¹¹ are each hydrogen. In a further specific embodiment, R⁹ and R¹⁰ are each hydrogen and R¹¹ is —COOH.

Synthetic poly(carboxylic acids) (A) are understood to mean polymers preparable by addition polymerization of ethylenically unsaturated carboxylic acids. Preferred synthetic poly(carboxylic acids) contain structural units derived from acrylic acid, methacrylic acid, crotonic acid, maleic acid, itaconic acid or mixtures thereof. The term “derived structural units” means that the polymer contains structural units which form in the addition polymerization of the acids mentioned. Particular preference is given to homopolymers of said ethylenically unsaturated carboxylic acids, for example poly(acrylic acid), and poly(methacrylic acid). Additionally preferred are copolymers of two or more, for example three or more, ethylenically unsaturated carboxylic acids and especially of the abovementioned ethylenically unsaturated carboxylic acids, for example of acrylic acid and maleic acid or of acrylic acid and itaconic acid.

The process according to the invention is also suitable for modification of poly(carboxylic acids) which, as well as the structural units derived from the abovementioned ethylenically unsaturated carboxylic acids, contain minor amounts of up to 50 mol % of structural units derived from further ethylenically unsaturated monomers. Preferably, the proportion of the structural units derived from further ethylenically unsaturated monomers is between 0.1 and 40 mol %, more preferably between 0.5 and 25 mol % and especially between 1 and 10 mol %, for example between 2 and 5 mol %. Preferred further ethylenically unsaturated monomers are, for example, monomers bearing further acid groups and especially monoethylenically unsaturated compounds having carboxyl groups, for example vinylacetic acid or allylacetic acid, having sulfate or sulfo groups, for example vinylsulfonic acid, allylsulfonic acid, methallylsulfonic acid, 3-sulfopropyl acrylate, 3-sulfopropyl methacrylate, 2-acrylamido-2-methylpropanesulfonic acid (AMPS) or 2-methacrylamido-2-methylpropanesulfonic acid, and also monoethylenically unsaturated compounds having phosphate or phosphonic acid groups, for example vinylphosphoric acid, vinylphosphonic acid, allylphosphonic acid, methacrylamidomethanephosphonic acid, 2-acrylamido-2-methylpropane-phosphonic acid, 3-phosphonopropyl acrylate or 3-phosphonopropyl methacrylate. Also suitable as further comonomers are vinyl esters of C₁-C₂₀-carboxylic acids and especially C₂-C₅-carboxylic acids, for example vinyl acetate and vinyl propionate, esters of acrylic acid and methacrylic acid with C₁-C₂₀-alcohols and especially C₂-C₆-alcohols, for example methyl(meth)acrylate, ethyl(meth)acrylate, propyl(meth)acrylate, hydroxyethyl(meth)acrylate and hydroxypropyl(meth)acrylate, and also acrylamide and methacrylamide and the derivatives thereof substituted on the nitrogen by C₁-C₂₀-alkyl radicals, vinyl ethers, for example methyl vinyl ether, N-vinyl compounds, for example N-vinylcaprolactam and N-vinylpyrrolidone, and also olefins, for example ethylene, styrene and butadiene. Preferred copolymers are homogeneously soluble or at least swellable in the solvent mixture of water and the water-miscible organic solvent at temperatures above 40° C., for example at 50° C., 60° C., 70° C., 80° C. or 90° C. Further preferably, they are homogeneously soluble or swellable in the solvent mixture at a concentration of at least 1% by weight and especially 5 to 90% by weight, for example 20 to 80% by weight, at temperatures above 40° C., for example at 50° C., 60° C., 70° C., 80° C. or 90° C. Examples of preferred copolymers are copolymers of
acrylic acid or methacrylic acid and 2-acrylamido-2-methylpropanesulfonic acid (AMPS®) sodium salt,
acrylic acid and 2-ethylhexyl acrylate,
acrylic acid and acrylamide,
acrylic acid and dimethylacrylamide,
methacrylic acid or acrylic acid with tert-butyl methacrylate,
maleic acid and styrene, and
maleic acid and vinyl acetate.

In copolymers of various ethylenically unsaturated carboxylic acids, and also in copolymers of ethylenically unsaturated carboxylic acids with further comonomers, the structural units of the formula (I) derived from ethylenically unsaturated carboxylic acids may be distributed in blocks, in alternation or randomly.

The synthetic poly(carboxylic acids) (A) contain at least 10 repeat structural units of the formula (I), which is to be understood as being per polymer chain.

Poly(carboxylic acids) (A) preferred in accordance with the invention have number-average molecular weights above 700 g/mol, more preferably between 1000 and 500,000 g/mol and especially between 2000 and 300,000 g/mol, for example between 2500 and 100,000 g/mol, in each case determined by means of gel permeation chromatography against poly(styrenesulfonic acid) standards. Additionally preferably, the poly(carboxylic acids) (A) have an average of at least 10 and especially at least 20, for example 50 to 8000, carboxyl groups per polymer chain. They contain, per polymer chain, preferably at least 20 and especially at least 50 structural units of the formula (I).

The process of the invention is suitable with preference for the preparation of secondary amides, in other words for the reaction of poly(carboxylic acids) (A) with amines of the formula (II) in which R¹ is a hydrocarbyl radical having 3 to 50 carbon atoms and R² is hydrogen.

The process of the invention is also suitable with preference for preparing tertiary amides, in other words for the reaction of poly(carboxylic acids) (A) with amines of the formula (II) in which R¹ is a hydrocarbyl radical having 3 to 50 carbon atoms and R² is a hydrocarbyl radical having 1 to 100 carbon atoms. The radicals R¹ and R² in this case may be the same or different. In one particularly preferred embodiment R¹ and R² are the same. In one specific embodiment R¹ and R² form a ring, together with the nitrogen atom to which they are bonded.

In a first preferred embodiment, R¹ is an aliphatic radical. This preferably has 4 to 24, more preferably 5 to 18 and especially 6 to 12 carbon atoms. The aliphatic radical may be linear, branched or cyclic. It may additionally be saturated or unsaturated. The aliphatic radical is preferably saturated. The aliphatic radical may bear substituents, for example hydroxyl, C₁-C₅-alkoxy, cyano, nitrile, nitro and/or C₅-C₂₀-aryl groups, for example phenyl radicals. The C₅-C₂₀-aryl radicals may in turn optionally be substituted by halogen atoms, halogenated alkyl radicals, C₁-C₂₀-alkyl, C₂-C₂₀-alkenyl, hydroxyl, C₁-C₅-alkoxy, for example methoxy, amide, cyano, nitrile and/or nitro groups. In a particularly preferred embodiment, R¹ is a C₃-C₆-alkyl or -cycloalkyl radical. These radicals may bear up to three substituents. Particularly preferred aliphatic radicals R¹ are n-propyl, isopropyl, n-butyl, isobutyl and tert-butyl, n-pentyl, isoamyl, n-hexyl, cyclohexyl, n-octyl, n-decyl, n-dodecyl, tridecyl, isotridecyl, tetradecyl, hexadecyl, octadecyl and methylphenyl.

R² is preferably hydrogen. In another preferred embodiment, R² is an aliphatic radical. This radical has preferably 1 to 24, more preferably 2 to 18, and especially 3 to 6 carbon atoms. The aliphatic radical may be linear, branched or cyclic. It may also be saturated or unsaturated. The aliphatic radical is preferably saturated. The aliphatic radical may carry substituents such as, for example, hydroxyl, C₁-C₅-alkoxy, cyano, nitrile, nitro and/or C₅-C₂₀-aryl groups, for example phenyl radicals.

The C₅-C₂₀-aryl radicals may in turn optionally be substituted by halogen atoms, halogenated alkyl radicals, C₁-C₂₀-alkyl, C₂-C₂₀-alkenyl, hydroxyl-, C₁-C₅-alkoxy, for example methoxy, amide, cyano, nitrile and/or nitro groups. In one particularly preferred embodiment, R² is hydrogen, a C₁-C₆-alkyl or C₃-C₆-cycloalkyl radical, and especially an alkyl radical having 1, 2 or 3 carbon atoms. These radicals may carry up to three substituents. Particularly preferred aliphatic radicals R² are methyl, ethyl, n-propyl, isopropyl, n-butyl, isobutyl and tert-butyl, n-hexyl, cyclohexyl, n-octyl, n-decyl, n-dodecyl, tridecyl, isotridecyl, tetradecyl, hexadecyl, octadecyl and methylphenyl.

In a further preferred embodiment, R¹ and R², together with the nitrogen atom to which they are bonded, form a ring. This ring has preferably 4 or more, for example 4, 5, 6 or more, ring members. Preferred further ring members in this case are carbon, nitrogen, oxygen and/or sulfur atoms. The rings may in turn carry substituents, for example alkyl radicals. Suitable ring structures are, for example, morpholinyl, pyrrolidinyl, piperidinyl, imidazolyl and azepanyl radicals.

In a further preferred embodiment, R¹ and R² are each independently an optionally substituted C₆-C₁₂-aryl group or an optionally substituted heteroaromatic group having 5 to 12 ring members.

In a further preferred embodiment, R¹ and R² are each independently an alkyl radical interrupted by heteroatoms. Particularly preferred heteroatoms are oxygen and nitrogen.

For instance, R¹ and R² each independently preferably represent radicals of the formula (III)

—(R³—O)ₙ—R⁴ (III)

in which

R³ is an alkylene group having 2 to 6 carbon atoms and preferably having 2 to 4 carbon atoms, for example ethylene, propylene, butylene or mixtures thereof,

R⁴ is hydrogen, a hydrocarbyl radical having 1 to 24 carbon atoms, an acyl radical of the formula —C(═O)—R¹² in which R¹² is a hydrocarbyl radical having 1 to 50 carbon atoms, or a group of the formula —R³—NR⁵R⁶,

n is a number between 2 and 100, preferably between 3 and 500 and especially between 4 and 25, for example between 5 and 10, and

R⁵, R⁶ are each independently hydrogen, an aliphatic radical having 1 to 24 carbon atoms and preferably 2 to 18 carbon atoms, an aryl group or heteroaryl group having 5 to 12 ring members, a poly(oxyalkylene) group having 1 to 50 poly(oxyalkylene) units, where the polyoxyalkylene units derive from alkylene oxide units having 2 to 6 carbon atoms, or R⁵ and R⁶ together with the nitrogen atom to which they are bonded form a ring having 4, 5, 6 or more ring members.

Polyetheramines (B) in which at least one of the radicals R¹ and/or R² corresponds to the formula (Ill) and are particularly suitable in accordance with the invention are obtainable, for example, by alkoxylation of alcohols of the formula R⁴—OH with 2 to 100 mol of ethylene oxide, propylene oxide or a mixture thereof and subsequent conversion of the terminal hydroxyl group into an amino group. Preferred polyetheramines have molecular weights between 500 and 7000 g/mol and more preferably between 600 and 5000 g/mol, for example between 800 and 2500 g/mol.

With further preference R¹ and/or R² independently of one another are radicals of the formula (IV)

—[R⁷—N(R⁸)]ₘ—(R⁸) (IV)

in which

R⁷ is an alkylene group having 2 to 6 carbon atoms and preferably having 2 to 4 carbon atoms, for example ethylene, propylene or mixtures thereof,

each R⁸ independently of any other is hydrogen, an alkyl or hydroxyalkyl radical having up to 24 carbon atoms, for example 2 to 20 carbon atoms, a polyoxyalkylene radical —(R³—O)ₚ—R⁴, or a polyiminoalkylene radical —[R⁷—N(R⁸)]_{q}—(R⁸), where R³, R⁴, R⁷ and R⁸ have the meanings given above, and q and p each independently are 1 to 50, and

m is a number from 1 to 20 and preferably 2 to 10, for example three, four, five or six. The radicals of the formula (I) contain preferably 1 to 50, in particular 2 to 20, nitrogen atoms.

Depending on the stoichiometric ratio between poly(carboxylic acid) (A) and polyamine of formula (IV), one or more amino groups, each carrying at least one hydrogen atom, are converted to the carboxamide. In the case of the reaction of poly(carboxylic acids) (A) with polyamines of the formula III, it is also possible for primary amino groups to be converted to imides.

Examples of suitable amines are n-propylamine, isopropylamine, propanolamine, butylamine, hexylamine, cyclohexylamine, octylamine, decylamine, dodecylamine, tetradecylamine, hexadecylamine, octadecylamine, dimethylamine, diethylamine, diethanolamine, ethylmethylamine, di-n-propylamine, diisopropylamine, methyl-n-propylamine, methyl-isopropylamine, dicyclohexylamine, didecylamine, didodecyl-amine, ditetradecylamine, dihexadecylamine, dioctadedcylamine, benzylamine, phenylethylamine, ethylenediamine, diethylenetriamine, triethylenetetramine, tetraethylenepentamine, N,N-dimethylethylenediamine, N,N-diethylaminopropyl-amine, N,N-dimethylaminopropylamine, N,N-(2″-hydroxyethyl)-1,3-propane-diamine, polyether amines with 2 to 50 mol of alkylene oxide such as ethylene oxide and/or propylene oxide, and 1-(3-aminopropyl)pyrrolidine, and also mixtures thereof. Particularly preferred among these are dimethylamine, diethylamine, diethanolamine, methyl-n-propylamine, methyl-isopropylamine, di-n-propylamine, diisopropylamine, ethylmethylamine, methoxyethoxypropylamine and N,N-dimethylaminopropylamine.

In the process according to the invention, poly(carboxylic acid) (A) and amine (B) can generally be reacted with one another in any desired ratios. Preferably, the reaction is effected with molar ratios between carboxyl groups of the poly(carboxylic acid) (A) and amino groups of the amine (B) of 100:1 to 1:5, preferably of 10:1 to 1:1 and especially of 5:1 to 2:1, based in each case on the equivalents of carboxyl and amino groups. If the amine is used in excess or is reacted incompletely, proportions thereof remain unconverted in the polymer, and these can remain in the product or be removed depending on the end use. This process is particularly advantageous when the amine used is volatile or water-soluble. “Volatile” means here that the amine has a boiling point at standard pressure of preferably below 250° C., for example below 150° C., and can thus be removed from the amide, optionally together with solvent. This can be effected, for example, by means of distillation, phase separation or extraction. Through the ratio of amine to carboxyl groups of the polymer, it is possible to adjust the degree of modification and hence the properties of the product.

The process according to the invention is suitable with particular preference for the partial amidation of poly(carboxylic acids) (A). This involves using the amine (B) in substoichiometric amounts, based on the total number of carboxyl groups, particularly in a ratio of 1:100 to 1:2 and especially in a ratio of 1:50 to 1:5, for example in a ratio of 1:20 to 1:8. Preference is given to adjusting the reaction conditions such that at least 10 mol %, particularly 20 to 100 mol % and especially 25 to 80 mol %, for example 30 to 70 mol %, of the amine (B) used is converted. These partial amidations form very homogeneous products, which is shown by a good solubility and a narrow cloud point of aqueous solutions.

If R¹ and/or R² represent a hydrocarbyl radical substituted with one or more hydroxyl groups, the reaction between poly(carboxylic acid) (A) and amine (B) is preferably effected with molar ratios of 1:1 to 1:5 and especially of 1:1.01 to 1:3, for example of 1:1.1 to 1:2, based in each case on the molar equivalents of carboxyl groups and amino groups in the reaction mixture.

The production of the reaction mixture used for the process according to the invention, which comprises poly(carboxylic acid) (A), amine (B), water, a water-miscible solvent and optionally further assistants, for example emulsifier, catalyst and/or electrolyte, can be effected in various ways. The ammonium salt formed in the process is preferably produced in-situ and not isolated. The mixing of poly(carboxylic acid) (A) and amine (B) can be performed continuously, batchwise or else in semibatchwise processes. Especially for processes on the industrial scale, it has been found to be useful to feed the reactants to the process according to the invention in liquid form. For this purpose, the poly(carboxylic acid) (A) is fed to the process according to the invention preferably as a solution in water or as a solution in water and a water-miscible solvent. The poly(carboxylic acid) (A) can also be used in swollen form, if this is pumpable.

The amine (B) can be used as such if it is liquid or meltable at low temperatures of preferably below 150° C. and especially below 100° C. In many cases, it has been found to be useful to use the amine (B) optionally in the molten state, in admixture with water and/or the water-miscible solvent, for example as a solution, dispersion or emulsion.

The mixing of poly(carboxylic acid) (A) with amine (B) can be performed in a (semi)batchwise process, by sequential charging of the constituents, for example in a separate stirred vessel. In a preferred embodiment, the amine (B) is dissolved in the water-miscible organic solvent and then added to the already dissolved or swollen polymer. Preference is given to addition in small portions over a prolonged period and while stirring, in order firstly to ensure a homogeneous distribution of the amine and secondly to avoid local precipitation of the polymer at the metering site.

Particular preference is given to mixing poly(carboxylic acid) (A) with amine (B) or solutions or dispersions thereof as described above and optionally further assistants in a mixing zone, from which the reaction mixture, optionally after intermediate cooling, is conveyed into the reaction zone.

If used, a catalyst and further assistants can be added to one of the reactants or else to the reactant mixture prior to entry into the reaction zone. It is also possible to convert heterogeneous systems by the process according to the invention, in which case merely appropriate industrial apparatus for conveying the reaction mixture is required.

The reaction mixture contains preferably 10 to 99% by weight, more preferably 20 to 95% by weight, especially 25 to 90% by weight, for example 50 to 80% by weight, of a solvent mixture of water and one or more water-miscible organic solvents. In each case, water is added to the reactants A and B prior to irradiation with microwaves, such that the reaction product contains an amount of water exceeding the amount of water of reaction released in the amidation.

Preferred water-miscible organic solvents are polar protic, and also polar aprotic liquids. These preferably have a dielectric constant, measured at 25° C., of at least 12 and especially at least 15. Preferred solvents are soluble in water to an extent of at least 100 g/l, more preferably to an extent of at least 200 g/l and particularly to an extent of at least 500 g/l, and are especially completely water-miscible. Particularly preferred solvents are heteroaliphatic compounds and especially alcohols, ketones, end-capped polyethers, carboxamides, for example tertiary carboxamides, nitriles, sulfoxides and sulfones. Preferred aprotic solvents are, for example, formamide, N,N-dimethylformamide (DMF), N,N-dimethylacetamide, acetone, γ-butyrolactone, acetonitrile, sulfolane and dimethyl sulfoxide (DMSO). Preferred protic organic solvents are lower alcohols having 1 to 10 carbon atoms and especially having 2 to 5 carbon atoms. Examples of suitable alcohols are methanol, ethanol, n-propanol, isopropanol, n-butanol, isobutanol, tert-butanol, n-pentanol, 2-pentanol, 3-pentanol, 2-methyl-1-butanol, isoamyl alcohol, 2-methyl-2-butanol, ethylene glycol and glycerol. Particularly preferred lower alcohols are secondary and tertiary alcohols. Particular preference is given to secondary and tertiary alcohols having 3 to 5 carbon atoms, for example isopropanol, sec-butanol, 2-pentanol and 2-methyl-2-butanol, and also neopentyl alcohol. Mixtures of the solvents mentioned are also suitable in accordance with the invention.

In general, low-boiling liquids are preferred as water-miscible organic solvents, particularly those which have a boiling point at standard pressure below 150° C. and especially below 120° C., for example below 100° C., and can thus be removed again from the reaction products with a low level of complexity. High-boiling solvents have been found to be useful, especially when they can remain in the product for the further use of the modified polymers. The proportion of the water-miscible organic solvents in the solvent mixture is preferably between 1 and 60% by weight, more preferably between 2 and 50% by weight, especially between 5 and 40% by weight, for example between 10 and 30% by weight, based in each case on the weight of the solvent mixture. Water is present in the solvent mixture ad 100% by weight.

To further lower the viscosity of the reaction mixture used and/or of the solution of the polymer-analogously modified polymer formed in the course of the process according to the invention, it has been found to be useful in many cases to add electrolytes to the reaction mixture. Preference is given here to strong electrolytes present completely in dissociated form irrespective of concentration. Preferred strong electrolytes are salts of alkali metals and alkaline earth metals, for example the chlorides, phosphates, sulfates, carbonates and hydrogencarbonates thereof. Examples of preferred strong electrolytes are NaCl, KCl, Na₂CO₃, Na₂SO₄ and MgSO₄. The addition of electrolytes simultaneously increases the dielectric loss of the reaction medium, such that more energy can be injected into the reaction mixture per unit time or volume. For the continuous process according to the invention, this means an increase in the amount convertible per unit time, since more reaction mixture can be heated to the desired temperature in the reaction zone with increasing flow rate (and simultaneously increasing microwave energy injected).

In the case of use of amines (B) having limited solubility in water or the mixture of water and water-miscible organic solvent, in a preferred embodiment, one or more emulsifiers can be added to the reaction mixture. Preference is given to using emulsifiers which are chemically inert with respect to the reactants and the product. In a particularly preferred embodiment, the emulsifier is reaction product from separate preparation.

In a preferred embodiment, the reactants are fed to the reaction zone from separate vessels in the desired ratio. In a specific embodiment, prior to entry into the reaction zone and/or in the reaction zone itself, they are homogenized further by means of suitable mixing elements, for example a static mixer and/or archimedean screw and/or by flowing through a porous foam.

According to the invention, the reaction of poly(carboxylic acid) (A) with amine (B) is effected under the influence of microwave radiation in a reaction zone. The reaction zone comprises at least one vessel in which the reaction mixture is exposed to microwave radiation (irradiation zone), and optionally an isothermal reaction zone which follows downstream thereof in flow direction, and in which the conversion can be completed. In the simplest case, the reaction zone consists of the irradiation zone. In the irradiation zone, the reaction mixture is heated by microwave radiation preferably to temperatures above 110° C., more preferably to temperatures between 120 and 320° C., especially between 130 and 260° C. and especially between 140 and 240° C., for example between 150 and 220° C. These temperatures relate to the maximum temperatures attained during the microwave irradiation. The temperature can be measured, for example, at the surface of the irradiation vessel. It is preferably determined in the reaction mixture directly after it leaves the irradiation zone. The pressure in the reaction zone is preferably set at such a level that the reaction mixture remains in the liquid state and does not boil. Preference is given to working at pressures above 1 bar, preferably at pressures between 3 and 300 bar, more preferably between 5 and 200 and especially between 10 and 100 bar, for example between 15 and 50 bar.

To accelerate or to complete the reaction, it has been found to be useful in many cases to work in the presence of dehydrating catalysts. Dehydrating catalysts are understood to mean auxiliaries which accelerate the condensation of amine and carboxylic acid. It is preferable to work in the presence of an acidic inorganic, organometallic or organic catalyst or mixtures of two or more of these catalysts. Preferred catalysts are liquid and/or soluble in the reaction medium. Furthermore, 0.01 to 10% by weight, preferably 0.02 to 2% by weight, of catalyst is preferably used. In a particularly preferred embodiment, no catalyst is used.

After the microwave irradiation, the reaction mixture in many cases can be sent directly to a further use. In order to obtain solvent-free products, water and/or organic solvent can be removed from the crude product by customary separation processes, for example distillation, freeze-drying or absorption. At the same time, it is also possible to additionally remove amine used in excess and any unconverted residual amounts of amine. For specific requirements, the crude products can be purified further by customary purifying processes, for example washing, reprecipitation, filtration, dialysis or chromatographic processes. In this case, it has also often proven successful to neutralize excess or unreacted amine and remove it by washing.

The microwave irradiation is typically performed in instruments which possess an irradiation vessel made from a very substantially microwave-transparent material, into which microwave irradiation generated in a microwave generator is injected. Microwave generators, for example the magnetron, the klystron and the gyrotron, are known to those skilled in the art.

The irradiation vessels used to perform the process according to the invention are preferably manufactured from substantially microwave-transparent, high-melting material or comprise at least parts, for example windows, made of these materials. Particular preference is given to using nonmetallic irradiation vessels. Substantially microwave-transparent materials are understood here to mean those which absorb a minimum amount of microwave energy and convert it to heat. A measure often employed for the ability of a substance to absorb microwave energy and convert it to heat is the dielectric loss factor tan δ=ε″/ε′. The dielectric loss factor tan δ is defined as the ratio of dielectric loss ε″ and dielectric constant ε′. Examples of tan δ values of different materials are reproduced, for example, in D. Bogdal,

Microwave-assisted Organic Synthesis, Elsevier 2005. For irradiation vessels suitable in accordance with the invention, materials with tan δ values measured at 2.45 GHz and 25° C. of less than 0.01, particularly less than 0.005 and especially less than 0.001 are preferred. Preferred microwave-transparent and thermally stable materials include primarily mineral-based materials, for example quartz, alumina, zirconia, silicon nitride and the like. Also suitable as vessel materials are thermally stable plastics such as, more particularly, fluoropolymers, for example Teflon, and industrial plastics such as polypropylene, or polyaryl ether ketones, for example glass fiber reinforced polyetheretherketone (PEEK). In order to withstand the temperature conditions during the reaction, especially minerals, such as quartz or alumina, coated with these plastics have been found to be useful as vessel materials.

Microwaves refer to electromagnetic rays with a wavelength between about 1 cm and 1 m and frequencies between about 300 MHz and 30 GHz. This frequency range is suitable in principle for the process according to the invention. For the process according to the invention, preference is given to using microwave radiation with frequencies approved for industrial, scientific and medical applications, for example with frequencies of 915 MHz, 2.45 GHz, 5.8 GHz or 24.12 GHz. The microwave irradiation of the reaction mixture can be effected either in microwave applicators which work in monomode or quasi-monomode, or in those which work in multimode. Corresponding instruments are known to those skilled in the art.

The microwave power to be injected into the irradiation vessel for the performance of the process according to the invention is dependent especially on the target reaction temperature, the geometry of the irradiation vessel and the associated reaction volume, and on the flow rate of the reaction mixture through the irradiation vessel. It is typically between 100 W and several hundreds of kW and especially between 200 W and 100 kW, for example between 500 W and 70 kW. It can be applied at one or more points in the irradiation vessel. It can be generated by means of one or more microwave generators.

The duration of the microwave irradiation depends on various factors, such as the reaction volume, the geometry of the irradiation vessel, the desired residence time of the reaction mixture at reaction temperature, and the desired degree of conversion. Typically, the microwave irradiation is undertaken over a period of less than 30 minutes, preferably between 0.01 second and 15 minutes, more preferably between 0.1 second and 10 minutes, and especially between one second and 5 minutes, for example between 5 seconds and 2 minutes. The intensity (power) of the microwave radiation is adjusted such that the reaction mixture attains the target reaction temperature within a minimum time. In a further preferred embodiment of the process according to the invention, it has been found to be useful to supply the reaction mixture to the irradiation vessel in heated form. To maintain the reaction temperature, the reaction mixture can be irradiated further with reduced and/or pulsed power, or kept to temperature by some other means.

In a preferred embodiment, the reaction product is cooled directly after the microwave irradiation has ended, very rapidly to temperatures below 100° C., preferably below 80° C. and especially below 50° C.

The microwave irradiation is preferably effected in a flow tube which serves as an irradiation vessel, which is also referred to hereinafter as reaction tube. It can additionally be performed in semibatchwise processes, for example continuous stirred reactors or cascade reactors. In a preferred embodiment, the reaction is performed in a closed, pressure-resistant and chemically inert vessel, in which case the water and in some cases the amine and the water-miscible solvent lead to a pressure buildup. After the reaction has ended, the elevated pressure can be used, by decompression, to volatilize and remove water, organic solvent and any excess amine and/or to cool the reaction product. In a particularly preferred embodiment, the reaction mixture, after the microwave irradiation has ended or after leaving the irradiation vessel, is freed very rapidly from water and any catalytically active species present, in order to avoid hydrolysis of the amide formed. The water and the organic solvent can be removed by customary separation processes, for example freeze drying, distillation or absorption. In this case, it has also often proven successful to neutralize excess or unreacted amine and remove it by washing.

In a particularly preferred embodiment of the process according to the invention, the reaction mixture is conducted continuously through a pressure-resistant reaction tube which is inert with respect to the reactants, is very substantially microwave-transparent, has been installed into a microwave applicator and serves as the irradiation zone. This reaction tube preferably has a diameter of one millimeter to approx. 50 cm, especially between 2 mm and 35 cm, for example between 5 mm and 15 cm. The diameter of the reaction tube is more preferably less than the penetration depth of the microwaves into the reaction mixture to be irradiated. It is particularly 1 to 70% and especially 5 to 60%, for example 10 to 50%, of the penetration depth. Penetration depth is understood to mean the distance over which the incident microwave energy is attenuated to 1/e.

Flow tubes or reaction tubes are understood here to mean irradiation vessels in which the ratio of length to diameter of the irradiation zone (this is understood to mean the portion of the flow tube in which the reaction mixture is exposed to microwave radiation) is greater than 5, preferably between 10 and 100,000, more preferably between 20 and 10,000, for example between 30 and 1000. They may, for example, be straight or curved, or else take the form of a pipe coil. In a specific embodiment, the reaction tube is configured in the form of a jacketed tube through whose interior and exterior the reaction mixture can be conducted successively in countercurrent, in order, for example, to increase the thermal conduction and energy efficiency of the process. The length of the reaction tube is understood to mean the total distance through which the reaction mixture flows in the microwave field. Over its length, the reaction tube is surrounded by at least one microwave radiator, but preferably by more than one, for example two, three, four, five, six, seven, eight or more microwave radiators. The microwaves are preferably injected through the tube jacket. In a further preferred embodiment, the microwaves are injected by means of at least one antenna via the tube ends.

The reaction zone is typically provided at the inlet with a metering pump and a manometer, and at the outlet with a pressure-retaining device and a heat exchanger. Preferably, the reaction mixture is fed to the reaction zone in liquid form with temperatures below 100° C., for example between 10° C. and 90° C. In a further preferred embodiment, a solution of the polymer (A) and amine (B) is mixed only shortly prior to entry into the reaction zone, optionally with the aid of suitable mixing elements, for example static mixers and/or archimedean screw and/or by flowing through a porous foam. In a further preferred embodiment, they are homogenized further in the reaction zone by means of suitable mixing elements, for example a static mixer and/or archimedean screw and/or by flowing through a porous foam.

Through variation of tube cross section, length of the irradiation zone, flow rate, geometry of the microwave radiators, the incident microwave power and the temperature attained, the reaction conditions are adjusted such that the maximum reaction temperature is achieved very rapidly. In a preferred embodiment, the residence time chosen at maximum temperature is short, such that as low as possible a level of side reactions and further reactions occurs.

Preferably, the continuous microwave reactor is operated in monomode or quasi-monomode. The residence time of the reaction mixture in the irradiation zone is generally below 20 minutes, preferably between 0.01 second and 10 minutes, preferably between 0.1 second and 5 minutes, for example between one second and 3 minutes. To complete the reaction, the reaction mixture, optionally after intermediate cooling, can flow through the irradiation zone several times.

In a particularly preferred embodiment, the irradiation of the reaction mixture with microwaves is effected in a reaction tube whose longitudinal axis is in the direction of propagation of the microwaves in a monomode microwave applicator. The length of the irradiation zone is preferably at least half the wavelength, more preferably at least the wavelength and up to 20 times, especially 2 to 15 times, for example 3 to 10 times, the wavelength of the microwave radiation used. With this geometry, energy from a plurality of, for example two, three, four, five, six or more, successive maxima of the microwave which propagates parallel to the longitudinal axis of the tube can be transferred to the reaction mixture, which distinctly improves the energy efficiency of the process.

The irradiation of the reaction mixture with microwaves is preferably effected in a substantially microwave-transparent straight reaction tube within a hollow conductor which functions as a microwave applicator and is connected to a microwave generator. The reaction tube is preferably aligned axially with a central axis of symmetry of this hollow conductor. The hollow conductor preferably takes the form of a cavity resonator. The length of the cavity resonator is preferably such that a standing wave forms therein. Additionally preferably, the microwaves not absorbed in the hollow conductor are reflected at the end thereof. Configuration of the microwave applicator as a resonator of the reflection type achieves a local increase in the electrical field strength at the same power supplied by the generator and increased energy exploitation.

The cavity resonator is preferably operated in E₀₁ₙ mode where n is an integer and specifies the number of field maxima of the microwave along the central axis of symmetry of the resonator. In this mode of operation, the electrical field is directed in the direction of the central axis of symmetry of the cavity resonator. It has a maximum in the region of the central axis of symmetry and decreases to the value of zero toward the outer surface. This field configuration is rotationally symmetric about the central axis of symmetry. Use of a cavity resonator with a length where n is an integer enables the formation of a standing wave. According to the desired flow rate of the reaction mixture through the reaction tube, the temperature required and the residence time required in the resonator, the length of the resonator is selected relative to the wavelength of the microwave radiation used. n is preferably an integer from 1 to 200, more preferably from 2 to 100, particularly from 3 to 50, especially from 4 to 20, for example three, four, five, six, seven, eight, nine or ten. The E₀₁ₙ mode of the cavity resonator is also referred to in English as the TM₀₁ₙ (transversal magnetic) mode; see, for example, K. Lange, K. H. Löcherer, “Taschenbuch der Hochfrequenztechnik” [Handbook of High-Frequency Technology], volume 2, pages K21 ff.

The microwave energy can be injected into the hollow conductor which functions as the microwave applicator through holes or slots of suitable dimensions. In a specific embodiment of the process according to the invention, the reaction mixture is irradiated with microwaves in a reaction tube present in a hollow conductor with coaxial crossing of the microwaves. Microwave devices particularly preferred for this process are formed from a cavity resonator, a coupling device for injecting a microwave field into the cavity resonator and with one orifice each on two opposite end walls for passage of the reaction tube through the resonator. The microwaves are preferably injected into the cavity resonator by means of a coupling pin which projects into the cavity resonator. The coupling pin is preferably configured as a preferably metallic inner conductor tube which functions as a coupling antenna. In a particularly preferred embodiment, this coupling pin projects through one of the end orifices into the cavity resonator. The reaction tube more preferably adjoins the inner conductor tube of the coaxial crossing, and is especially conducted through the cavity thereof into the cavity resonator. The reaction tube is preferably aligned axially with a central axis of symmetry of the cavity resonator, for which the cavity resonator preferably has a central orifice on each of two opposite end walls to pass the reaction tube through.

The microwaves can be fed into the coupling pin or into the inner conductor tube which functions as a coupling antenna, for example, by means of a coaxial connecting line. In a preferred embodiment, the microwave field is supplied to the resonator via a hollow conductor, in which case the end of the coupling pin projecting out of the cavity resonator is conducted into the hollow conductor through an orifice in the wall of the hollow conductor, and takes microwave energy from the hollow conductor and injects it into the resonator.

In a specific embodiment, the reaction mixture is irradiated with microwaves in a microwave-transparent reaction tube which is axially symmetric within an E₀₁ₙ round hollow conductor with coaxial crossing of the microwaves. The reaction tube is conducted through the cavity of an inner conductor tube which functions as a coupling antenna into the cavity resonator. In a further preferred embodiment, the reaction mixture is irradiated with microwaves in a microwave-transparent reaction tube which is conducted through an E₀₁ₙ cavity resonator with axial introduction of the microwaves, the length of the cavity resonator being such as to form n=2 or more field maxima of the microwave. In a further preferred embodiment, the reaction mixture is irradiated with microwaves in a microwave-transparent reaction tube which is conducted through an E₀₁ₙ cavity resonator with axial introduction of the microwaves, the length of the cavity resonator being such as to form a standing wave where n=2 or more field maxima of the microwave. In a further preferred embodiment, the reaction mixture is irradiated with microwaves in a microwave-transparent reaction tube which is axially symmetric within a circular cylindrical E₀₁ₙ cavity resonator with coaxial crossing of the microwaves, the length of the cavity resonator being such as to form n=2 or more field maxima of the microwave. In a further preferred embodiment, the reaction mixture is irradiated with microwaves in a microwave-transparent reaction tube which is axially symmetric within a circular cylindrical E₀₁ₙ cavity resonator with coaxial crossing of the microwaves, the length of the cavity resonator being such as to form a standing wave where n=2 or more field maxima of the microwave.

E₀₁ cavity resonators particularly suitable for the process according to the invention preferably have a diameter which corresponds to at least half the wavelength of the microwave radiation used. The diameter of the cavity resonator is preferably 1.0 to 10 times, more preferably 1.1 to 5 times and especially 2.1 to 2.6 times half the wavelength of the microwave radiation used. The E₀₁ cavity resonator preferably has a round cross section, which is also referred to as an E₀₁ round hollow conductor. It more preferably has a cylindrical shape and especially a circular cylindrical shape.

On departure from the irradiation zone, the conversion of the reaction mixture is often not yet in chemical equilibrium. In a preferred embodiment, the reaction mixture is therefore, after passing through the irradiation zone, transferred directly, i.e. without intermediate cooling, into an isothermal reaction zone in which it continues to be kept at reaction temperature for a certain time. Only after leaving the isothermal reaction zone is the reaction mixture optionally decompressed and cooled. Direct transfer from the irradiation zone to the isothermal reaction zone is understood to mean that no active measures are taken for supply and more particularly for removal of heat between irradiation zone and isothermal reaction zone. Preferably, the temperature difference between departure from the irradiation zone and entry into the isothermal reaction zone is less than ±30° C., preferably less than ±20° C., more preferably less than ±10° C. and especially less than ±5° C. In a specific embodiment, the temperature of the reaction mixture on entry into the isothermal reaction zone corresponds to the temperature on departure from the irradiation zone. This embodiment enables rapid and controlled heating of the reaction mixture to the desired reaction temperature without partial overheating, and then residence at this reaction temperature for a defined period before it is cooled. In this embodiment, the reaction mixture is preferably, directly after leaving the isothermal reaction zone, cooled very rapidly to temperatures below 120° C., preferably below 100° C. and especially below 60° C.

Useful isothermal reaction zones include all chemically inert vessels which enable residence of the reaction mixtures at the temperature established in the irradiation zone. An isothermal reaction zone is understood to mean that the temperature of the reaction mixture in the isothermal reaction zone relative to the entrance temperature is kept constant within ±30° C., preferably within ±20° C., more preferably within ±10° C. and especially within ±5° C. Thus, the reaction mixture on departure from the isothermal reaction zone has a temperature which deviates from the temperature on entry into the isothermal reaction zone by not more than ±30° C., preferably ±20° C., more preferably ±10° C. and especially ±5° C.

In addition to continuous stirred tanks and tank cascades, especially tubes are suitable as the isothermal reaction zone. These reaction zones may consist of different materials, for example metals, ceramic, glass, quartz or plastics, with the proviso that they are mechanically stable and chemically inert under the selected temperature and pressure conditions. It has been found that thermally insulated vessels are particularly useful. The residence time of the reaction mixture in the isothermal reaction zone can be adjusted, for example, via the volume of the isothermal reaction zone. In the case of use of stirred tanks and tank cascades, it has been found to be equally useful to establish the residence time via the fill level of the tanks. In a preferred embodiment, the isothermal reaction zone is equipped with active or passive mixing elements.

In a preferred embodiment, the isothermal reaction zone used is a tube. This may be an extension of the microwave-transparent reaction tube downstream of the irradiation zone, or else a separate tube of the same or different material connected to the reaction tube. For a given flow rate, the residence time of the reaction mixture can be determined over the length of the tube and/or cross section thereof. The tube which functions as the isothermal reaction zone is thermally insulated in the simplest case, such that the temperature which exists on entry of the reaction mixture into the isothermal reaction zone is held within the limits given above. However, it is also possible, for example by means of a heat carrier or cooling medium, to supply energy in a controlled manner to the reaction mixture in the isothermal reaction zone, or remove it therefrom. This embodiment has been found to be useful especially for startup of the apparatus or of the process. For example, the isothermal reaction zone may be configured as a tube coil or as a tube bundle which is within a heating or cooling bath or is charged with a heating or cooling medium in the form of a jacketed tube. The isothermal reaction zone may also be within a further microwave applicator in which the reaction mixture is treated once again with microwaves. In this case, it is possible to use either monomode or multimode applicators.

The residence time of the reaction mixture in the isothermal reaction zone is preferably such that the thermal equilibrium state defined by the existing conditions is attained. Typically, the residence time is between 1 second and 10 hours, preferably between 10 seconds and 2 hours, more preferably between 20 seconds and 60 minutes, for example between 30 seconds and 30 minutes. Additionally preferably, the ratio between residence time of the reaction mixture in the isothermal reaction zone and residence time in the irradiation zone is between 1:2 and 100:1, more preferably 1:1 to 50:1 and especially between 1:1.5 and 10:1.

To achieve particularly high conversions, it has been found to be useful in many cases to expose the reaction product obtained again to microwave irradiation, in which case it is optionally possible to make up the ratio of the reactants used to compensate for spent or deficient reactants.

The process according to the invention enables the polymer-analogous modification of synthetic poly(carboxylic acids) with amines in a continuous process in volumes of industrial interest. Aside from water, this does not give rise to any by-products which have to be disposed of and pollute the environment. A further advantage of the process according to the invention lies in the fact that the polymer-analogous condensation reactions can be undertaken in aqueous solution, since water is one of the few solvents of suitability for poly(carboxylic acids). The addition of particular polar organic solvents can counteract any viscosity rise which occurs in the course of the process, and facilitates reaction with amines of relatively low water solubility. In this way, poly(carboxylic acids) can be modified, for example, to render them hydrophobic or thermally associative. The process according to the invention allows the reproducible preparation of products modified randomly along their chain length. The variety of amines available in industrial volumes for the process according to the invention opens up a wide range of possible modifications. It is thus possible in a simple manner to modify the properties of synthetic poly(carboxylic acids) within wide limits.

### EXAMPLES

The irradiation of the reaction mixtures with microwaves was effected in an alumina reaction tube (60×1 cm) which was present in axial symmetry in a cylindrical cavity resonator (60×10 cm). At one of the ends of the cavity resonator, the reaction tube ran through the cavity of an inner conductor tube which functions as a coupling antenna. The microwave field with a frequency of 2.45 GHz, generated by a magnetron, was injected into the cavity resonator by means of the coupling antenna (E₀₁ cavity applicator; monomode), in which a standing wave formed. In the case of use of an isothermal reaction zone, the heated reaction mixtures, immediately after leaving the reaction tube, were conveyed through a thermally insulated stainless steel tube (3.0 m×1 cm, unless stated otherwise). After leaving the reaction tube, or after leaving the isothermal reaction zone in the case of use thereof, the reaction mixtures were decompressed to atmospheric pressure, and cooled immediately to the temperature specified by means of an intensive heat exchanger.

The microwave power was adjusted over the experimental duration in each case in such a way that the desired temperature of the reaction mixture at the end of the irradiation zone was kept constant. The microwave powers specified in the experimental descriptions therefore represent the mean value of the incident microwave power over time. The measurement of the temperature of the reaction mixture was undertaken directly after departure from the irradiation zone by means of a Pt100 temperature sensor. Microwave energy not absorbed directly by the reaction mixture was reflected at the opposite end of the cavity resonator from the coupling antenna; the microwave energy which was also not absorbed by the reaction mixture on the return path and reflected back in the direction of the magnetron was passed with the aid of a prism system (circulator) into a water-containing vessel. The difference between energy injected and heating of this water load was used to calculate the microwave energy introduced into the reaction mixture.

By means of a high-pressure pump and of a pressure-release valve, the reaction mixture in the reaction tube was placed under such a working pressure that was sufficient always to keep all reactants and products or condensation products in the liquid state. The reaction mixtures were pumped through the apparatus at a constant flow rate and the residence time in the irradiation zone was adjusted by modifying the flow rate.

The reaction products were analyzed by means of ¹H NMR spectroscopy at 500 MHz in CDCl₃.

### Example 1

### Amidation of Poly(methacrylic acid) With Octylamine

A 10 l Büchi stirred autoclave with gas inlet tube, stirrer, internal thermometer and pressure equalizer was initially charged with a solution of 1.4 kg of poly(methacrylic acid) (molecular weight 5000 g/mol) in 5.6 kg of water, and 0.42 kg of octylamine (20 mol % based on the acid functions of the polymer) dissolved in 1 l of isopropanol was added while stirring over a period of one hour. The neutralization reaction of the amine with the acid was noticeable in a slight rise in temperature.

The reaction mixture thus obtained was pumped continuously through the reaction tube at 5.0 l/h and a working pressure of 25 bar and exposed to a microwave power of 2.4 kW, 88% of which was absorbed by the reaction mixture. The residence time of the reaction mixture in the irradiation zone was about 48 seconds. On departure from the reaction tube, the reaction mixture had a temperature of 207° C. and was transferred directly at this temperature to the isothermal reaction zone. At the end of the isothermal reaction zone, the reaction mixture had a temperature of 198° C. Directly after leaving the reaction zone, the reaction mixture was cooled to room temperature.

The reaction product was a homogeneous, colorless solution with slightly increased viscosity compared to the unreacted polymer solution. Evaporating off the solvent resulted in a hygroscopic, tacky material, the IR spectrum of which shows bands characteristic of secondary amides at 1665 and 1540 cm⁻¹ and a signal in the ¹H NMR spectrum at 3.15 ppm (NH—CH₂) with a line widening, characteristic of polymeric amides, of this methylene group adjacent to the amidic nitrogen atom. By comparison of the integral of the signal of the w-positioned CH₃ group of the octyl radical at 0.8-0.9 ppm with that of the (H₃N⁺—CH₂—) moiety of the ammonium salt precursor at 2.9 ppm, a conversion of approximately 91% was determined, based on the amount of amine used.

In pure water, the resulting polymer has only poor solubility, but can be brought to a clear solution by addition of small amounts of alkalis. The presence of the N-bonded alkyl side groups produces a weak association behavior, which is manifested in shear thinning behavior at low shear rates.

### Example 2

### Amidation of Poly(acrylic acid) With Methylisopropylamine

A 10 l Büchi stirred autoclave with gas inlet tube, stirrer, internal thermometer and pressure equalizer was initially charged with a solution of 1.4 kg of poly(acrylic acid) (molecular weight 5000 g/mol) in 5.6 kg of water, and the mixture was heated to 40° C. At this temperature, a solution of 355 g of methylisopropylamine (25 mol % based on the acid functions of the polymer) dissolved in 200 g of dimethylformamide was added while stirring over a period of one hour. Here too, the neutralization heat is indicated by a distinct rise in temperature.

The reaction mixture thus obtained was pumped continuously through the reaction tube at 4.8 l/h and a working pressure of 33 bar and exposed to a microwave power of 2.3 kW, 89% of which was absorbed by the reaction mixture. The residence time of the reaction mixture in the irradiation zone was about 50 seconds. On departure from the reaction tube, the reaction mixture had a temperature of 215° C. and was transferred directly at this temperature to the isothermal reaction zone. At the end of the isothermal reaction zone, the reaction mixture had a temperature of 199° C. Directly after leaving the reaction zone, the reaction mixture was cooled to room temperature.

The reaction product was a solution of pale yellowish color with low viscosity. Evaporating off the solvent resulted in a viscous material, the IR spectrum of which shows a band characteristic of tertiary amides at 1655 cm⁻¹. The conversion as determined by the ¹H NMR method described under experiment 1 was 89% of the amount of amine used. On the basis of the amount of methylisopropylamide moieties, an LCST behavior (viscosity increase of a 5% aqueous solution) of the resulting polymer at 33-38° C. was ascertained.

### Example 3

### Amidation of Poly(acrylic acid) With Poly(ether)amine

A 10 l Büchi stirred autoclave with gas inlet tube, stirrer, internal thermometer and pressure equalizer was initially charged with a solution of 4.0 kg of poly(acrylic acid) (molecular weight 2000 g/mol as 50% solution in water) in 3 kg of water and 1 kg of isopropanol, and the mixture was heated to 35° C. At this temperature, 2.77 kg of Jeffamine® M-1000 (10 mol % based on the acid functions of the polymer) dissolved in 1 kg of isopropanol were added while stirring over a period of one hour. Jeffamine M-1000 is a monofunctional poly(ether)amine produced by reaction of methanol with 19 mol of ethylene oxide and 3 mol of propylene oxide and subsequent conversion of the terminal OH groups into amino groups.

The reaction mixture thus obtained was pumped continuously through the reaction tube at 3.5 l/h and a working pressure of 27 bar and exposed to a microwave power of 2.4 kW, 91% of which was absorbed by the reaction mixture. The residence time of the reaction mixture in the irradiation zone was about 68 seconds. On departure from the reaction tube, the reaction mixture had a temperature of 225° C. and was cooled directly to room temperature.

The reaction product was a pale yellowish color and showed a distinctly increased viscosity (3000 mPas, Brookfield, 30° C.) compared to the unreacted polymer solution. Evaporating off the water resulted in a viscous material, the IR spectrum of which shows bands characteristic of secondary amides at 1660 and 1535 cm⁻¹. By means of the integration of the ¹H NMR signals of the CH₃ groups, adjacent to the nitrogen atoms, in the propylene units in the ammonium salt (1.3 ppm) and in the amide (1.22 ppm) (reactant and product), a conversion of 75% of the polyetheramine used was estimated.

### Example 4

### Attempted Amidation of Poly(acrylic acid) With Octylamine in Water (Comparative)

The method employed was analogous to experiment 1, except without addition of an organic solvent. By vigorous stirring of the initial charge, a homogeneous product solution was preparable only by vigorous stirring and heating of the reaction mixture to 55° C.

After departure from the reaction apparatus, the reaction product obtained showed distinct gel specks, which are indicative of polymer blocks with different degrees of modification.

### Example 5

### Attempted Amidation of Poly(acrylic acid) With Polyetheramine in Water (Comparative)

The method employed was analogous to experiment 3, except without addition of an organic solvent. To establish a comparable active ingredient concentration in the reaction mixture, the amount of the solvent used in experiment 3 was replaced by water and was added to the poly(acrylic acid). In the case of addition of the poly(ether)amine to the poly(acrylic acid) solution heated to 35° C., the viscosity of the reaction mixture rose perceptibly, but it still remained pumpable.

In the course of pumping of the reaction mixture through the reaction tube exposed to microwave radiation, there was a further distinct rise in viscosity, which led to stoppage of the pump and to termination of the experiment.

1. A continuous process for reacting synthetic poly(carboxylic acids) (A) containing at least 10 repeat structural units of the formula (I) 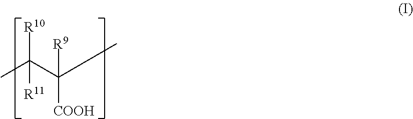
in which
R⁹ is hydrogen, a C₁- to C₄-alkyl group or a group of the formula —CH₂—COOH
R¹⁰ is hydrogen or a C₁- to C₄-alkyl group
R¹¹ is hydrogen, a C₁- to C₄-alkyl group or —COOH,
with amines (B) of the formula (II)
HNR¹R² (II)
in which
R¹ is a hydrocarbyl radical which has 3 to 50 carbon atoms and may be substituted or contain heteroatoms, and
R² is hydrogen or a hydrocarbyl radical which has 1 to 50 carbon atoms, which may be substituted or contain heteroatoms, or
R¹ and R² together with the nitrogen atom to which they are bonded form a ring, by introducing a reaction mixture comprising at least one synthetic poly(carboxylic acid) (A) and at least one amine of the formula (II) in a solvent mixture comprising water and, based on the weight of the solvent mixture, 0.1-75% by weight of at least one water-miscible organic solvent, where the organic solvent has a dielectric constant measured at 25° C. of at least 10, into a reaction zone, and exposing it to microwave radiation as it flows through the reaction zone, the reaction mixture in the reaction zone being heated to temperatures above 100° C. by the microwave irradiation.

2. The process as claimed in claim 1, in which the poly(carboxylic acid) (A) is a homopolymer of acrylic acid, methacrylic acid, crotonic acid, maleic acid, fumaric acid or itaconic acid or a copolymer of two or more of these monomers.

3. The process as claimed in claim 1, in which the poly(carboxylic acid) (A) is a copolymer of acrylic acid, methacrylic acid, crotonic acid, maleic acid, fumaric acid and/or itaconic acid, and at least one further ethylenically unsaturated monomer.

4. The process as claimed in one or more of claims 1 to 3, in which the poly(carboxylic acid) has a mean molecular weight of at least 700 g/mol.

5. The process as claimed in one or more of claims 1 to 4, in which the amine is a primary amine.

6. The process as claimed in one or more of claims 1 to 4, in which the amine is a secondary amine.

7. The process as claimed in one or more of claims 1 to 6, in which R¹ is an aliphatic radical.

8. The process as claimed in one or more of claims 1 to 7, in which R² is an aliphatic radical.

9. The process as claimed in one or more of claims 1 to 8, in which the amine is a polyether amine of the formula (III)
—(R³—O)ₙ—R⁴ (III)
in which
R³ is an alkylene group having 2 to 6 carbon atoms and preferably having 2 to 4 carbon atoms, for example ethylene, propylene, butylene or mixtures thereof,
R⁴ is hydrogen, a hydrocarbyl radical having 1 to 24 carbon atoms, an acyl radical of the formula —C(═O)—R¹² in which R¹² is a hydrocarbyl radical having 1 to 50 carbon atoms, or a group of the formula —R³—NR⁵R⁶,
n is a number between 2 and 100, preferably between 3 and 500 and especially between 4 and 25, for example between 5 and 10, and
R⁵, R⁶ are each independently hydrogen, an aliphatic radical having 1 to 24 carbon atoms and preferably 2 to 18 carbon atoms, an aryl group or heteroaryl group having 5 to 12 ring members, a poly(oxyalkylene) group having 1 to 50 poly(oxyalkylene) units, where the polyoxyalkylene units derive from alkylene oxide units having 2 to 6 carbon atoms, or R⁵ and R⁶ together with the nitrogen atom to which they are bonded form a ring having 4, 5, 6 or more ring members.

10. The process as claimed in one or more of claims 1 to 9, in which the amine is a polyamine of the formula (IV)
—[R⁷—N(R⁸)]ₘ—(R⁸) (IV)
in which
R⁷ is an alkylene group having 2 to 6 carbon atoms and preferably having 2 to 4 carbon atoms, for example ethylene, propylene or mixtures thereof,
each R⁸ independently of any other is hydrogen, an alkyl or hydroxyalkyl radical having up to 24 carbon atoms, for example 2 to 20 carbon atoms, a polyoxyalkylene radical —(R³—O)ₚ—R⁴, or a polyiminoalkylene radical —[R⁷—N(R⁸)L-(R⁸), where R³, R⁴, R⁷ and R⁸ have the meanings given above, and q and p each independently are 1 to 50, and
m is a number from 1 to 20 and preferably 2 to 10, for example three, four, five or six. The radicals of the formula (I) contain preferably 1 to 50, in particular 2 to 20, nitrogen atoms.

11. The process as claimed in one or more of claims 1 to 10, in which the reaction mixture used for conversion contains 10 to 99% by weight of a mixture of water and a water-miscible organic solvent.

12. The process as claimed in one or more of claims 1 to 11, in which the ratio between water and water-miscible organic solvent is between 10:1 and 1:5.

13. The process as claimed in one or more of claims 1 to 12, in which the water-miscible solvent is a protic organic liquid.

14. The process as claimed in claim 13, in which the water-miscible solvent is an alcohol.

15. The process as claimed in one or more of claims 1 to 12, in which the water-miscible solvent is an aprotic organic liquid.

16. The process as claimed in claim 15, in which the water-miscible solvent is selected from formamide, N,N-dimethylformamide (DMF), N,N-dimethylacetamide, acetone, γ-butyrolactone, acetonitrile, sulfolane and dimethyl sulfoxide (DMSO).

17. The process as claimed in one or more of claims 1 to 16, in which the reaction is performed at temperatures above 100° C.

18. The process as claimed in one or more of claims 1 to 17, in which the reaction mixture comprises an acidic catalyst.

19. The process as claimed in one or more of claims 1 to 18, in which the reaction mixture comprises a strong electrolyte.

20. The process as claimed in one or more of claims 1 to 19, in which the microwave irradiation is effected in a flow tube made from microwave-transparent, high-melting material.

21. The process as claimed in one or more of claims 1 to 20, in which the longitudinal axis of the reaction tube in the direction of propagation of the microwaves is within a monomode microwave applicator.

22. The process as claimed in one or more of claims 1 to 21, in which the microwave applicator takes the form of a cavity resonator.

23. The process as claimed in one or more of claims 1 and 3 to 22, in which the synthetic poly(carboxylic acids) (A) is a copolymer which contains the structural units of the formula (I) derived from ethylenically unsaturated carboxylic acids in block, alternating or random sequence.

24. Hydrophobically modified synthetic poly(carboxylic acids) preparable by the process as claimed in one of more of claims 1 to 23.
